(19) United States
(12) Patent Application Publication
(10) Pub. No.: US 2012/0297347 A1
(43) Pub. Date: Nov. 22, 2012

(54) GESTURE-BASED NAVIGATION CONTROL

(75) Inventors: Mark Molander, Research Triangle Park, NC (US); David Lection, Research Triangle Park, NC (US); Patrick Bohrer, Austin, TX (US); Todd Eischeid, Research Triangle Park, NC (US)

(73) Assignee: INTERNATIONAL BUSINESS MACHINES CORPORATION, Armonk, NY (US)

(21) Appl. No.: 13/111,331

(22) Filed: May 19, 2011

(51) Int. Cl. G06F 3/033

(52) U.S. Cl. 715/863

(57) ABSTRACT

A user interface may be provided by: displaying a graphical user interface including at least one graphical user interface element; receiving at least one gesture-based user input; displaying a graphical user interface including the at least one graphical user interface element and one or more graphical user interface elements that are hierarchically dependent from the at least one graphical user interface element in response to the at least one gesture-based user input.

### CROSS-REFERENCE TO RELATED APPLICATIONS

The present application is related to and claims the benefit of the earliest available effective filing date(s) from the following listed application(s) (the “Related Applications”) (e.g., claims earliest available priority dates for other than provisional patent applications or claims benefits under 35 USC §119(e) for provisional patent applications, for any and all parent, grandparent, great-grandparent, etc. applications of the Related Application(s)).

### RELATED APPLICATIONS

The present application constitutes a continuation-in-part of U.S. patent application Ser. No. ______, entitled SCALABLE GESTURE-BASED NAVIGATION CONTROL, naming Mark Molander, William Pagan, Devon Snyder and Todd Eischeid as inventors, filed May 6, 2011, which is currently co-pending, or is an application of which a currently co-pending application is entitled to the benefit of the filing date.

All subject matter of the Related Applications is incorporated herein by reference to the extent such subject matter is not inconsistent herewith.

### BACKGROUND

Gesturing is a quickly emerging user interface (UI) input mechanism. Such inputs may be applicable to various devices that include touch screen-based UIs employed by touch-sensitive devices (e.g. hand-held/mobile devices such as touch-screen enabled smart phones and tablet computers, large mounted displays, and the like).

Further, various navigation structures exist in applications for UIs to enable a user may to navigate between multiple UI pages to view desired data. UI designs may be configured to present such data in varying manners.

For example, a UI navigation structure may be used where data is displayed in a “flat” configuration using limited (e.g. only 1) levels of hierarchical navigation (e.g. large amounts of data are presented simultaneously and “drill-downs” to more detailed views of particular UI elements are limited). In such “flat” configurations, a user may navigate through substantial portions of data (including data and sub-data fields) provided by the UI by scrolling operations that traverse panels of the UI.

Alternately, a UI navigation structure may be used where data is displayed in a “deep” configuration using multiple levels of hierarchical navigation (e.g. limited amounts of data are presented simultaneously at a given level and use of “drill-downs” to more detailed views of particular UI elements are more extensive.) In such “deep” configurations, a user may navigate to more detailed data associated with a particular UI element by selecting that UI element at which point the UI transitions to a view associated with the selected UI element.

### SUMMARY

A user interface may be provided by displaying a graphical user interface including at least one graphical user interface element; receiving at least one gesture-based user input; and displaying a graphical user interface including the at least one graphical user interface element and one or more graphical user interface elements that are hierarchically dependent from the at least one graphical user interface element in response to the at least one gesture-based user input.

### BRIEF DESCRIPTION OF THE DRAWINGS

Figure Number:

FIG. 1 depicts a system for providing a user interface;

FIG. 2 depicts a user interface;

FIG. 3 depicts a user interface;

FIG. 4 depicts a method for providing a user interface;

FIG. 5 depicts a user interface;

FIG. 6 depicts a user interface;

FIG. 7 depicts a user interface;

FIG. 8 depicts a method for providing a user interface;

FIG. 9 depicts a user interface;

FIG. 10 depicts a user interface;

FIG. 11 depicts a user interface;

FIG. 12 depicts a user interface;

FIG. 13 depicts a user interface;

FIG. 14 depicts a method for providing a user interface;

FIG. 15 depicts a user interface;

FIG. 16 depicts a user interface;

FIG. 17 depicts a user interface;

FIG. 18 depicts a user interface;

FIG. 19 depicts a user interface; and

FIG. 20 depicts a user interface.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

As described above, UIs may be configured with varying levels of navigational depth. It may be the case that certain applications may benefit from UIs having multiple display modes configured to display representations of data at varying levels of navigational depth. As such, the present invention is directed to systems and methods for transitioning a UI between at least a first display mode having a substantially “flat” navigational depth and at least a second display mode having a relatively “deep” navigational depth as compared to the first display mode.

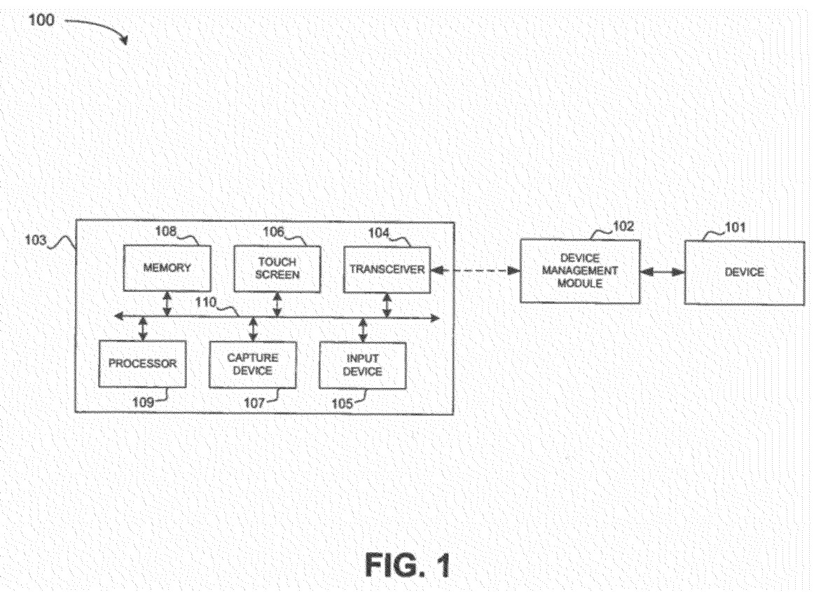

FIG. 1 depicts an exemplary system 100 for monitoring and/or controlling one or more controllable devices 101. At least in the illustrated embodiment, system 100 includes a device management module 102 configured to control at least one controllable device 101. The device management module 102 may be external to or included as a portion of controllable device 101. The system 100 may further include a gesture-based input device 103 (e.g. a touch-screen enabled tablet computer, smart phone, and the like) in communication with device management module 102.

The gesture-based input device 103 may include a transceiver 104, one or more input devices 105, a touch-sensitive screen 106, one or more capture devices 107, a memory 108, and a processor 109 coupled to one another via a bus 110 (e.g., a wired and/or wireless bus).

The transceiver 104 may be any system and/or device capable of communicating (e.g., transmitting and receiving data and/or signals) with device management module 102. The transceiver 104 may be operatively connected to device management module 102 via a wireless (e.g. Wi-Fi, Bluetooth, cellular data connections, etc.) or wired (Ethernet, etc.) connection.

The one or more input devices 105 may be any system and/or device capable of receiving input from a user. Examples of input devices 105 include, but are not limited to, a mouse, a key board, a microphone, a selection button, and the like input devices. In various embodiments, each input device 105 is in communication with touch-sensitive screen 106. In other embodiments, touch-sensitive screen 106 is itself, an input device 105.

In various embodiments, the touch-sensitive screen 106 may be configured to display data received from controllable devices 101, device management module 102, input devices 105, one or more capture devices 107, etc.

The capture devices 107 may be any system and/or device capable of capturing environmental inputs (e.g., visual inputs, audio inputs, tactile inputs, etc.). Examples of capture devices 107 include, but are not limited to, a camera, a microphone, a global positioning system (GPS), a gyroscope, a plurality of accelerometers, and the like.

The memory 108 may be any system and/or device capable of storing data. In one embodiment, memory 108 stores computer code that, when executed by processor 109, causes processor 109 to perform a method for controlling one or more controllable devices 101.

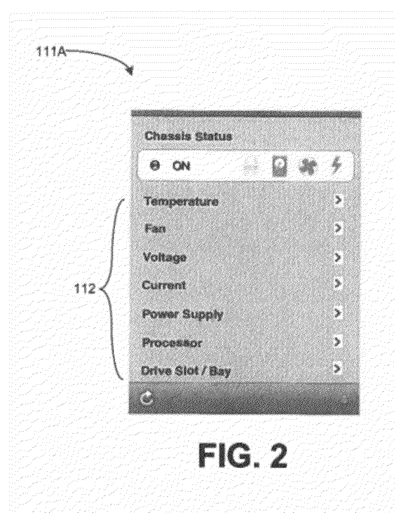

As shown in FIGS. 2-3, 5-13 and 15-20, the gesture-based input device 103 may be configured (e.g. running software and/or firmware stored in memory 108; employing application specific circuitry) to display a UI 111 under the touch-sensitive screen 106. The gesture-based input device 103 may provide device control signals to the controllable devices 101 according to one or more user inputs received by the gesture-based input device 103 that are associated with an element of the UI 111 associated with a controllable device 101 (e.g. a graphical or textual representation of a controllable device 101 displayed by the UI 111).

It may be desirable to monitor and/or control operations of the one or more controllable devices 101 via the UI 111 presented on the gesture-based input device 103.

For example, as shown in FIG. 2, a UI 111A may be provided that is associated with the status of at least one controllable device 101 (e.g. a server node chassis). The UI 111A may display one or more controllable device UI elements 112 associated with the controllable device 101. For example, the UI 111A may display controllable device UI elements 112 associated with the operational temperatures of one or more components of a controllable device 101, fan speeds of one or more fans of the controllable device 101, test voltages and/or currents of the controllable device 101, power supply status of the controllable device 101, processor status of the controllable device 101, drive slot/bay status of the controllable device 101, cabling status of the controllable device 101, and the like. The UI 111A of FIG. 2 may be characterized as having a relatively “deep” navigational depth in that only the controllable device UI elements 112 of controllable device 101 status data are presented but no hierarchically dependent data associated with those controllable device UI elements 112 is not presented.

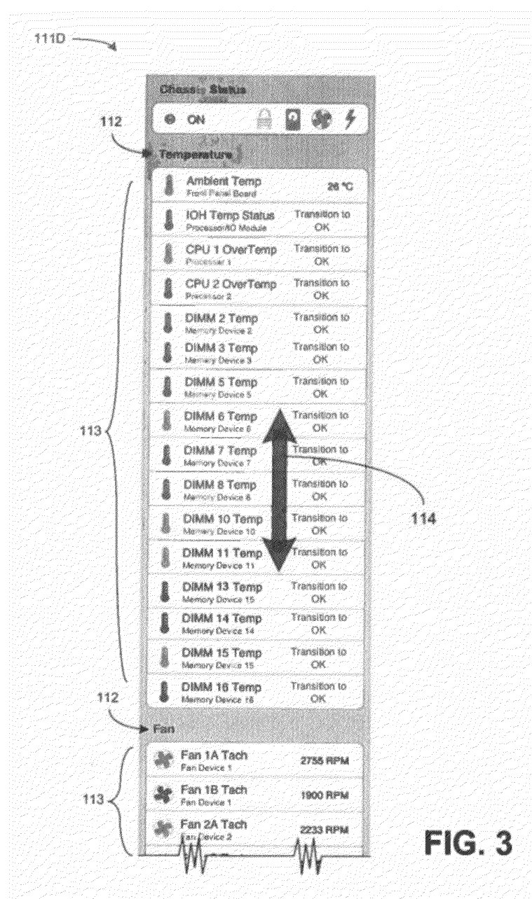

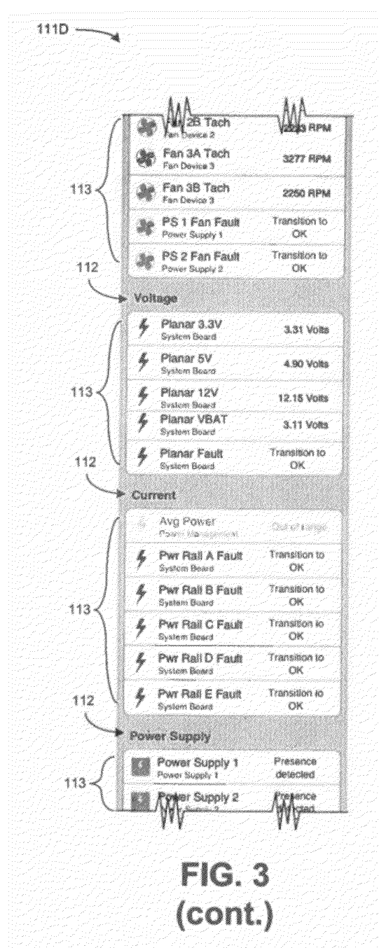

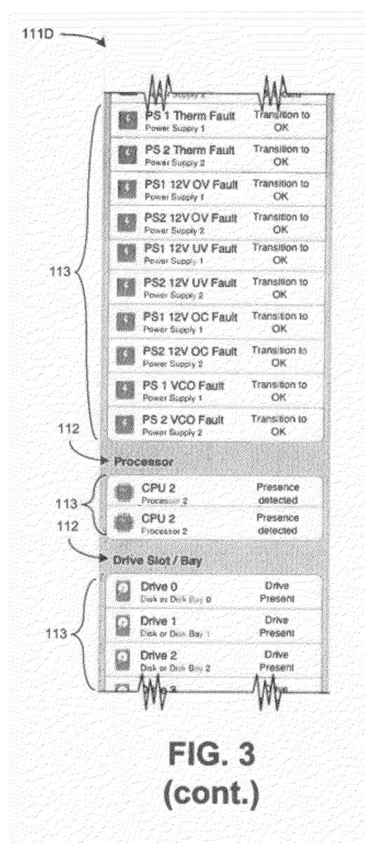

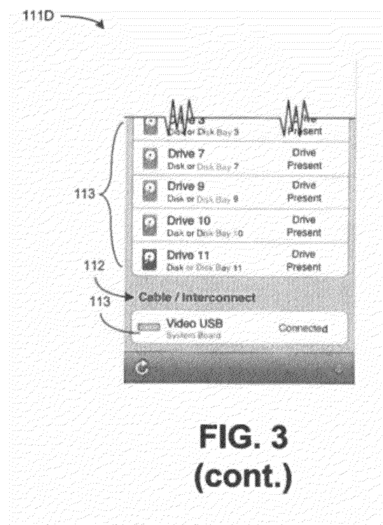

Alternately, as shown in FIG. 3, a UI 111D may be provided that is associated with the status of at least one controllable device 101 (e.g. a server node chassis). Similar to FIG. 2, the UI 111B may display one or more controllable device UI elements 112 associated with the controllable device 101. For example, the UI 111D may display controllable device UI elements 112 associated with the operational temperatures of one or more components of a controllable device 101, fan speeds of one or more fans of the controllable device 101, test voltages and/or currents of the controllable device 101, power supply status of the controllable device 101, processor status of the controllable device 101, drive slot/bay status of the controllable device 101, cabling status of the controllable device 101, and the like. However, in contrast to FIG. 2, the UI 111D of FIG. 3 may further include data associated with the controllable device UI elements 112. For example, the UI 111D may display data elements 113 associated with each controllable device UI element 112. The UI 111D of FIG. 3 may be characterized as having a substantially “flat” navigational depth in that both the controllable device UI elements 112 and all data elements 113 hierarchically dependent from those controllable device UI elements 112 are shown simultaneously. A user may navigate such a “flat” UI 111D through a scrolling-type user input 114.

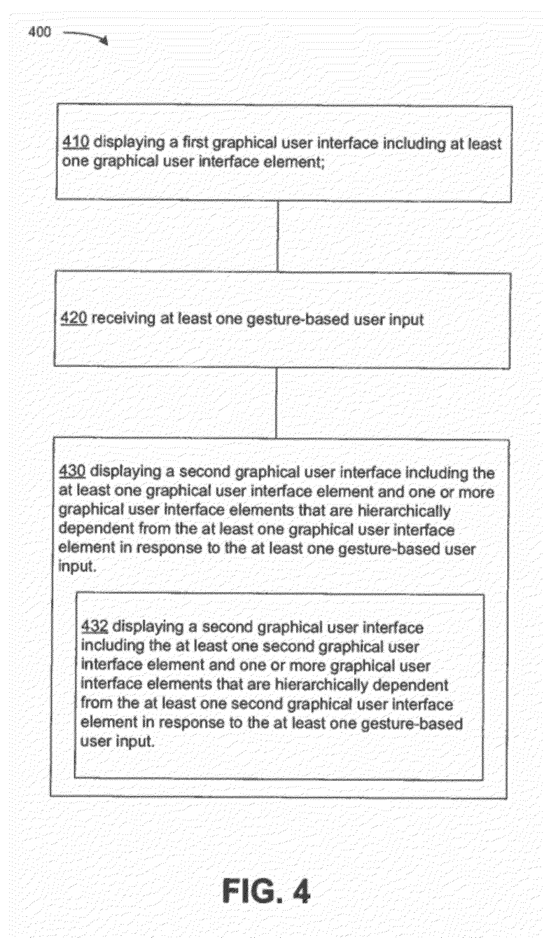

FIG. 4 illustrates an operational flow 400 representing example operations related to UI display configuration. In FIG. 4, discussion and explanation may be provided with respect to the above-described examples of FIGS. 1-3 and 5-6, and/or with respect to other examples and contexts. However, it should be understood that the operational flows may be executed in a number of other environments and contexts, and/or in modified versions of FIGS. 1-3 and 5-6. In addition, although the various operational flows are presented in the sequence(s) illustrated, it should be understood that the various operations may be performed in other orders than those that are illustrated, or may be performed concurrently.

Operation 410 illustrates displaying a graphical user interface including at least one graphical user interface element. For example, as shown in FIG. 2, the gesture-based input device 103 may display a UI 111A including one or more controllable device UI elements 112 associated with one or more functions of one or more controllable devices 101.

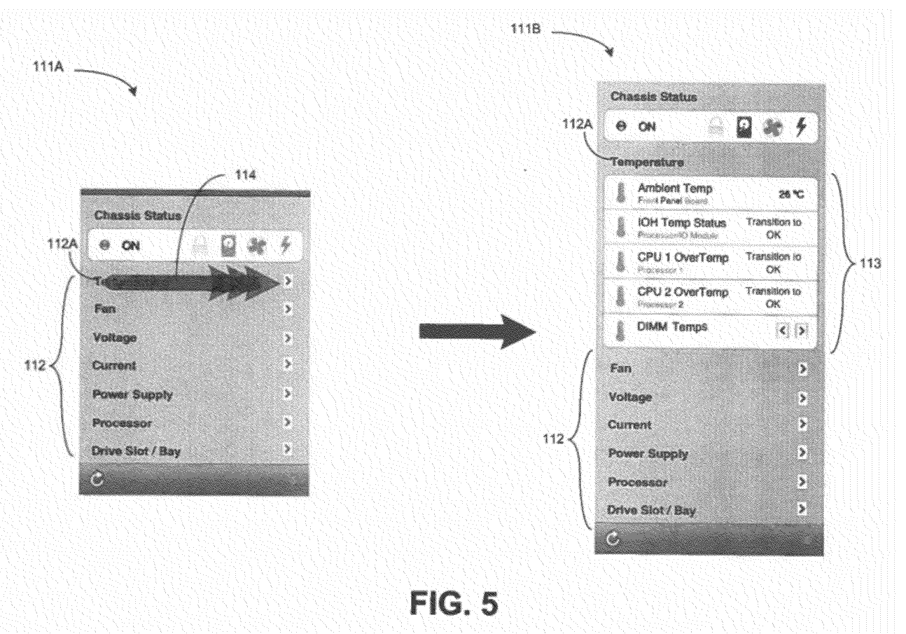

Operation 420 illustrates receiving at least one gesture-based user input For example, referring to FIG. 5, the gesture-based input device 103 may receive a user input 114 (e.g. a user touch applied to a surface of a touch-sensitive screen 106 of the gesture-based input device 103) at least partially associated with a particular controllable device UI element 112 (e.g. a user touch to the touch-sensitive screen 106 that corresponds to a location on the UI 111 at least partially proximate to where a controllable device UI element 112 is displayed). Referring to FIG. 5, an illustrated view of a user input 114 associated with a controllable device UI element 112A is shown. The user input 114 may be characterized by an at least substantially constant application of pressure (e.g. at no point does the user remove their finger from the surface entirely). Further, the user input 114 may be an at least partially dynamic user input. For example, upon touching the touch-sensitive screen 106, a user may move one or more fingers (e.g. three fingers) across the touch-sensitive screen 106 such as shown by the tracing of user input 114.

Operation 430 illustrates displaying a graphical user interface including the at least one graphical user interface element and one or more graphical user interface elements that are hierarchically dependent from the at least one graphical user interface element in response to the at least one gesture-based user input. For example, as shown in FIG. 5, upon receipt of the user input 114 associated with a controllable device UI element 112A, the gesture-based input device 103 may display a UI 111B including one or more data elements 113 that are hierarchically dependent from the controllable device UI element 112A associated with the user input 114 (e.g. provide data specific to the controllable device UI element 112A associated with the user input 114).

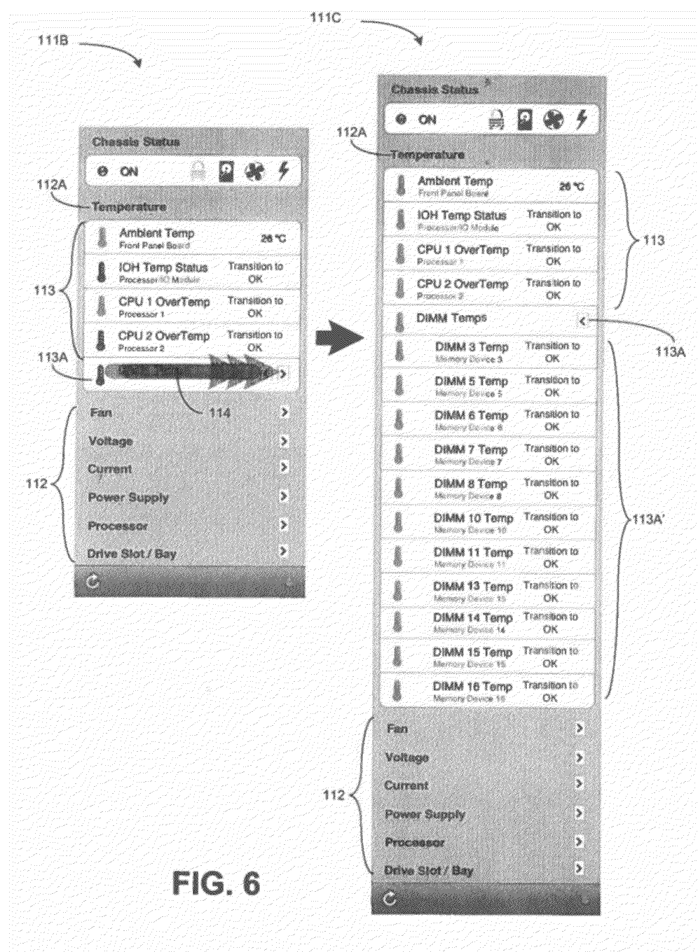

Operations 410 through 430 may be conducted in similar fashion with respect to data elements 113 to display additional user interface views including graphical representations of various status indicators dependent from those data elements 113. For example, as shown in FIG. 6, the gesture-based input device 103 may display the UI 111B including one or more data elements 113 that are hierarchically dependent from the controllable device UI element 112A associated with the user input 114.

The gesture-based input device 103 may receive a user input 114 (e.g. a user touch applied to a surface of a touch-sensitive screen 106 of the gesture-based input device 103) at least partially associated with a data element 113A that is hierarchically dependent from the controllable device UI element 112A (e.g. a user touch to the touch-sensitive screen 106 that corresponds to a location on the UI 111 at least partially proximate to where the data element 113A that is hierarchically dependent from the controllable device UI element 112A is displayed).

Upon receipt of the user input 114 associated with the data element 113A, the gesture-based input device 103 may display a UI 111C including one or more data elements 113B that are hierarchically dependent from the data element 113A associated with the user input 114 (e.g. providing data specific to the data element 113A associated with the user input 114).

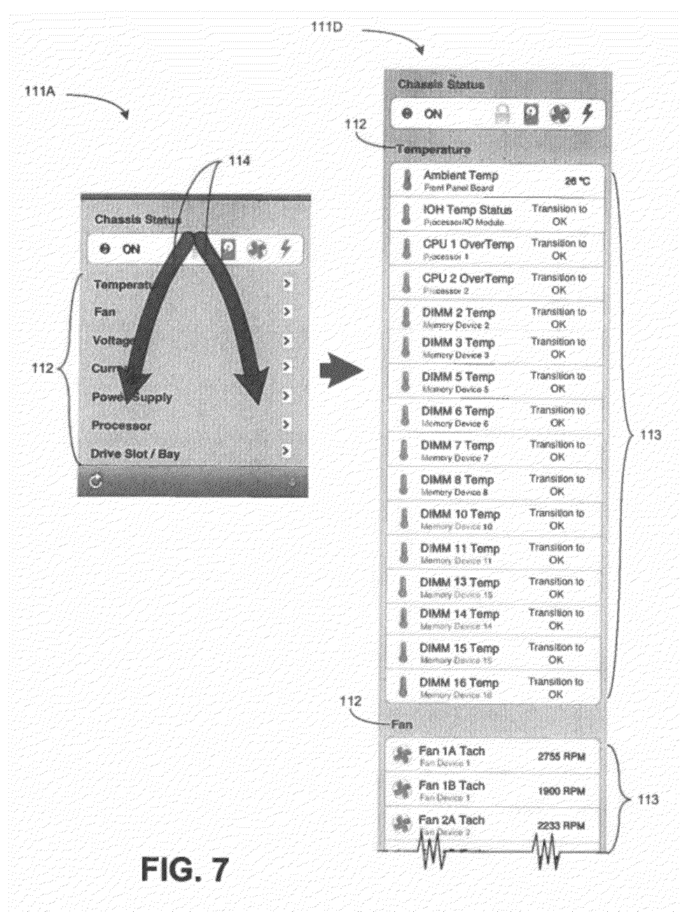

In an alternative embodiment, operation 432 illustrates displaying a second graphical user interface including the at least one second graphical user interface element and one or more graphical user interface elements that are hierarchically dependent from the at least one second graphical user interface element in response to the at least one gesture-based user input. For example, as shown in FIG. 7, upon receipt of a user input 114 (e.g. a downward and separating movement of two fingers in contact with the touch-sensitive screen 106), the gesture-based input device 103 may display a UI 111D including all data elements 113 that are hierarchically dependent from all controllable device UI elements 112 displayed on UI 111A (e.g. an “expand all” operation).

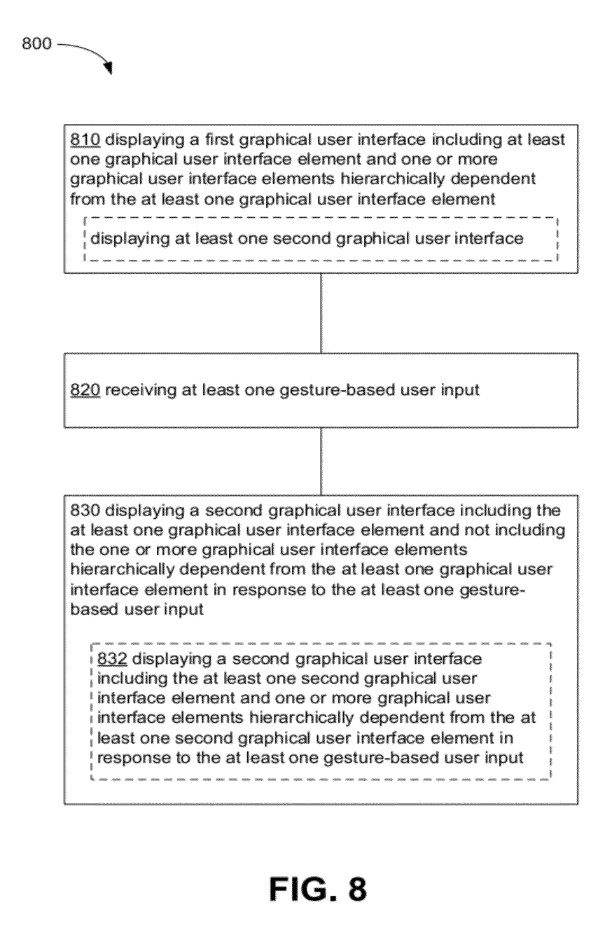

FIG. 8 illustrates an operational flow 800 representing example operations related to UI display configuration. In FIG. 8, discussion and explanation may be provided with respect to the above-described examples of FIGS. 1-3 and 9-10, and/or with respect to other examples and contexts. However, it should be understood that the operational flows may be executed in a number of other environments and contexts, and/or in modified versions of FIGS. 1-3 and 9-10. In addition, although the various operational flows are presented in the sequence(s) illustrated, it should be understood that the various operations may be performed in other orders than those that are illustrated, or may be performed concurrently.

Operation 810 illustrates displaying a graphical user interface including at least one graphical user interface element and one or more graphical user interface elements hierarchically dependent from the at least one graphical user interface element. For example, as shown in FIG. 3, the gesture-based input device 103 may display a UI 111D including one or more controllable device UI elements 112 associated with one or more functions of one or more controllable devices 101. Further, the UI 111D may include one or more data elements 113 that are hierarchically dependent from the controllable device UI element 112A associated with the user input 114A (e.g. provide data specific to the controllable device UI element 112A associated with the user input 114A).

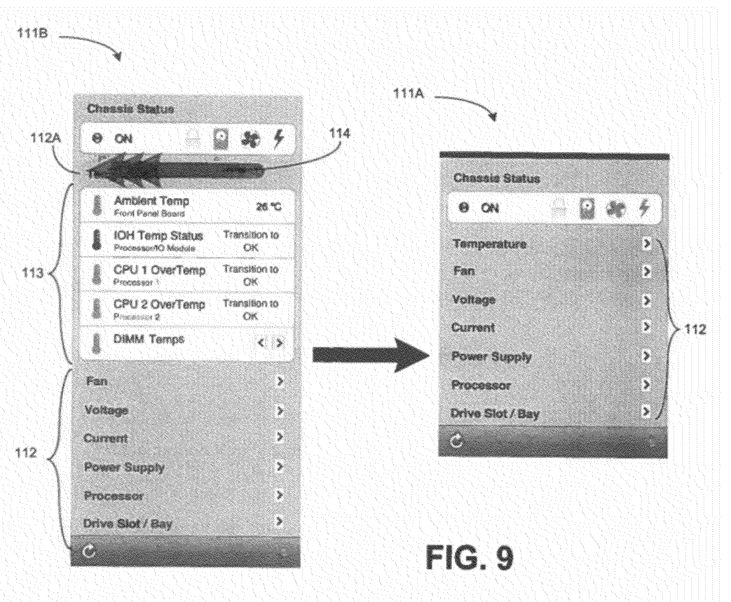

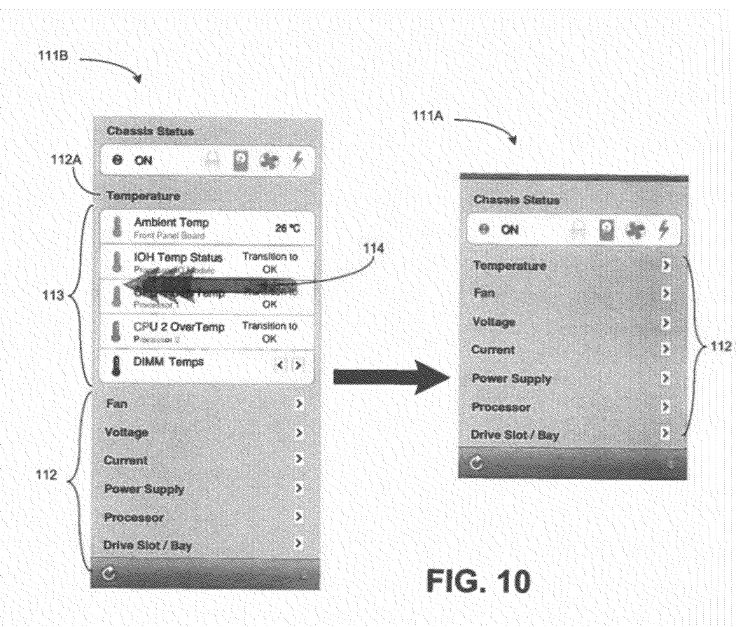

Operation 820 illustrates receiving at least one gesture-based user input For example, referring to FIGS. 9 and 10, the gesture-based input device 103 may receive a user input 114 (e.g. a user touch applied to a surface of a touch-sensitive screen 106 of the gesture-based input device 103) at least partially associated with a particular controllable device UI element 112 or data element 113 (e.g. a user touch to the touch-sensitive screen 106 that corresponds to a location on the UI 111 at least partially proximate to where a controllable device UI element 112 or data element 113 is displayed). Referring to FIG. 9, an illustrated view of a user input 114 associated with a controllable device UI element 112A is shown. The user input 114A may be characterized by an at least substantially constant application of pressure (e.g. at no point does the user remove their finger from the surface entirely). Further, the user input 114 may be an at least partially dynamic user input. For example, upon touching the touch-sensitive screen 106, a user may move one or more fingers (e.g. three fingers) across the touch-sensitive screen 106 such as shown by the tracing of user input 114. Referring to FIG. 10, an illustrated view of a user input 114 associated with a data element 113 is shown.

Operation 830 illustrates displaying a graphical user interface including the at least one graphical user interface element and not including the one or more graphical user interface elements hierarchically dependent from the at least one graphical user interface element in response to the at least one gesture-based user input. For example, as shown in FIGS. 9-10, upon receipt of the user input 114 associated with a controllable device UI element 112 or data element 113, the gesture-based input device 103 may display a UI 111A including the controllable device UI element 112A but does not display any data elements 113 that are hierarchically dependent from the controllable device UI element 112A.

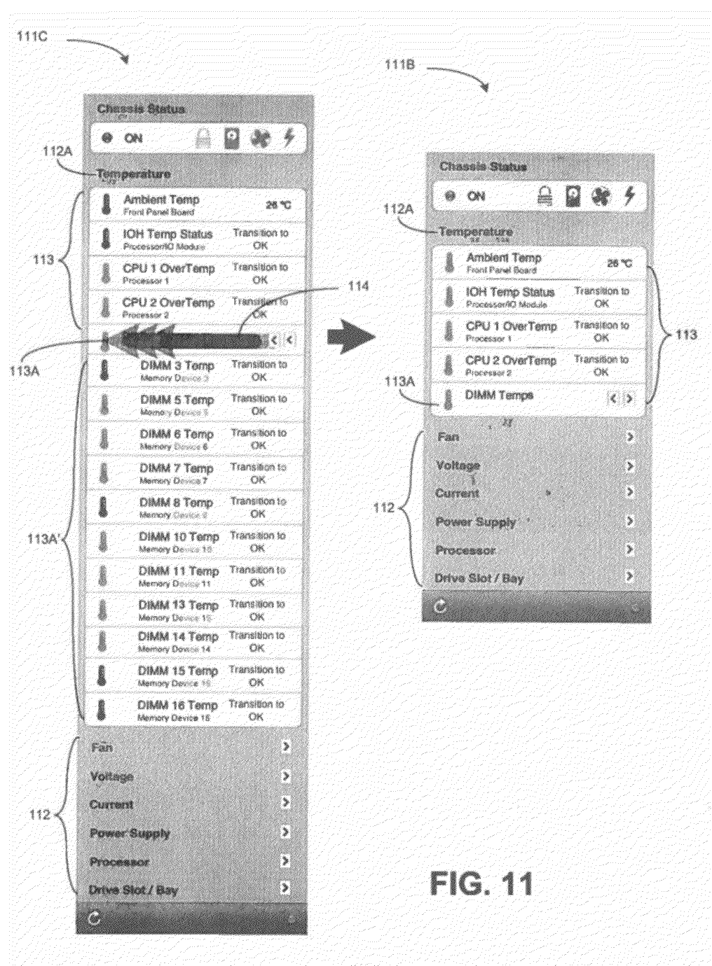

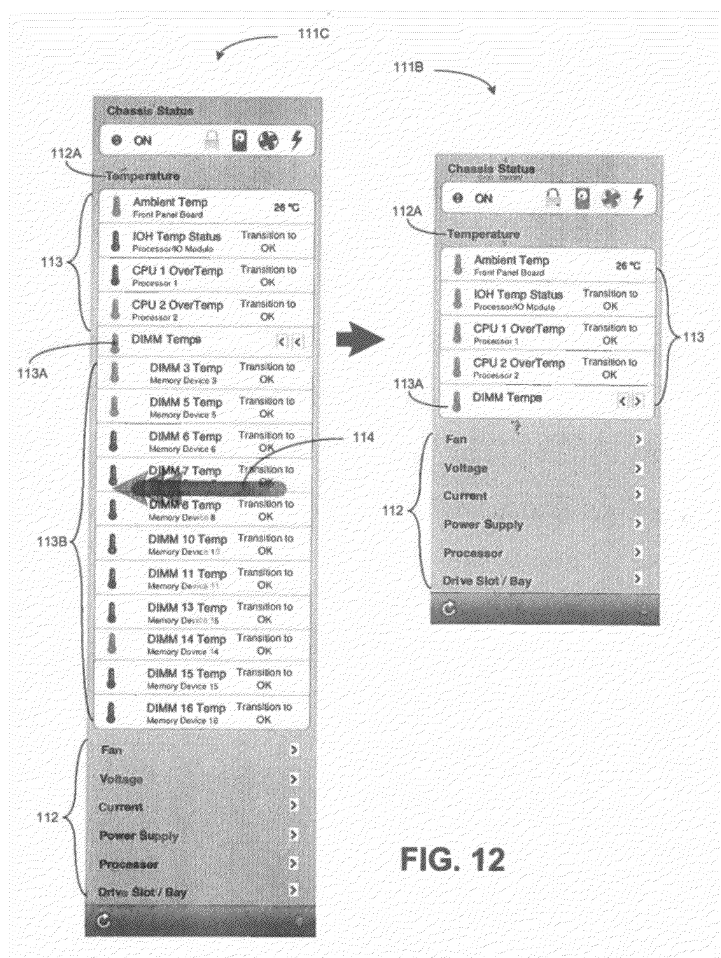

Operations 810 through 830 may be conducted in similar fashion with respect to data elements 113 to display additional user interface views including graphical representations of various status indicators dependent from those data elements 113. For example, as shown in FIGS. 11-12, the gesture-based input device 103 may display the UI 111C including one or more data elements 113B that are hierarchically dependent from data element 113A that is, itself, hierarchically dependent from a controllable device UI element 112A.

The gesture-based input device 103 may receive a user input user input 114 (e.g. a user touch applied to a surface of a touch-sensitive screen 106 of the gesture-based input device 103) at least partially associated with a data element 113A (as in FIG. 11) or data element 113B (as in FIG. 12) that is hierarchically dependent from the controllable device UI element 112A (e.g. a user touch to the touch-sensitive screen 106 that corresponds to a location on the UI 111 at least partially proximate to where the data element 113A or data element 113B is displayed).

Upon receipt of the user input 114 associated with the data element 113A or data element 113B, the gesture-based input device 103 may display a UI 111B including one or more data elements 113A that are hierarchically dependent from the controllable device UI element 112A but does not display the data elements 113B that are hierarchically dependent from the data elements 113A.

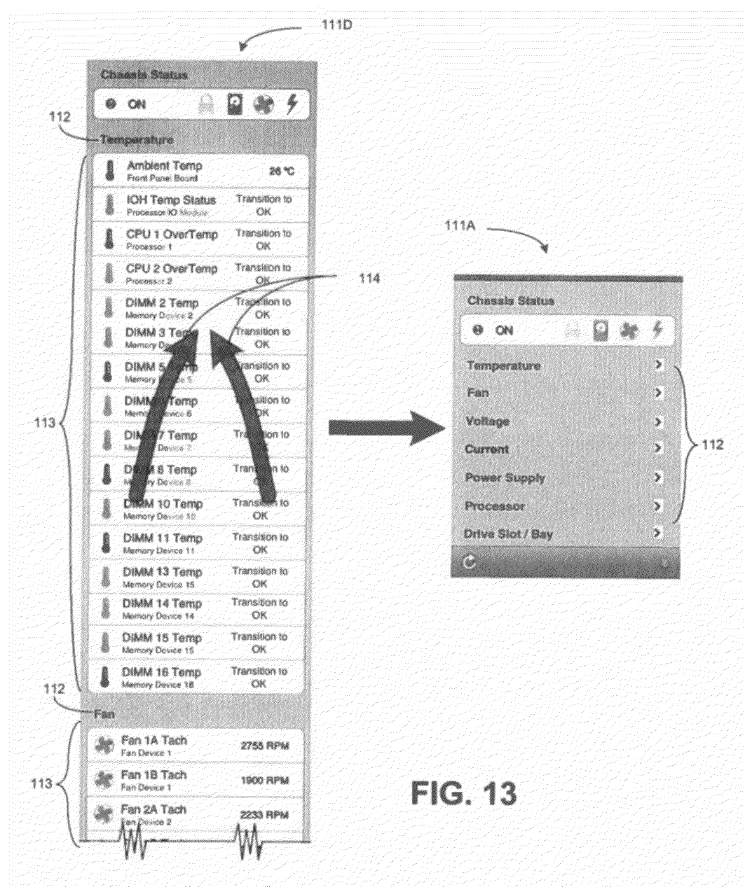

In an alternative embodiment, operation 832 illustrates displaying a graphical user interface including the at least one graphical user interface element and the at least one second graphical user interface element and not including the one or more graphical user interface elements hierarchically dependent from the at least one graphical user interface element and the one or more second graphical user interface elements hierarchically dependent from the at least one second graphical user interface element in response to the at least one gesture-based user input. For example, as shown in FIG. 13, upon receipt of a user input 114 (e.g. an upward and intersecting movement of two fingers in contact with the touch-sensitive screen 106), the gesture-based input device 103 may display a UI 111A including all controllable device UI elements 112 but no data elements 113 that are hierarchically dependent from those controllable device UI elements 112 that are displayed on UI 111D (e.g. an “condense all” operation).

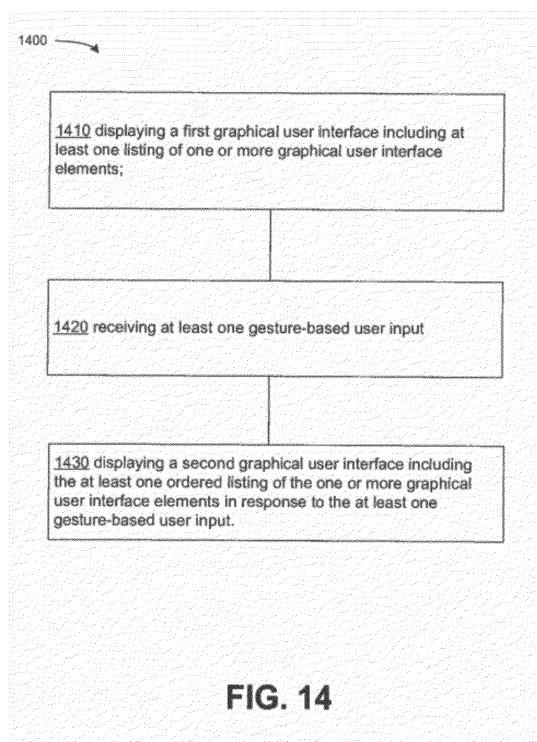

FIG. 14 illustrates an operational flow 1400 representing example operations related to UI display configuration. In FIG. 14, discussion and explanation may be provided with respect to the above-described examples of FIGS. 1-3 and 15-16, and/or with respect to other examples and contexts. However, it should be understood that the operational flows may be executed in a number of other environments and contexts, and/or in modified versions of FIGS. 1-3 and 15-16. In addition, although the various operational flows are presented in the sequence(s) illustrated, it should be understood that the various operations may be performed in other orders than those that are illustrated, or may be performed concurrently.

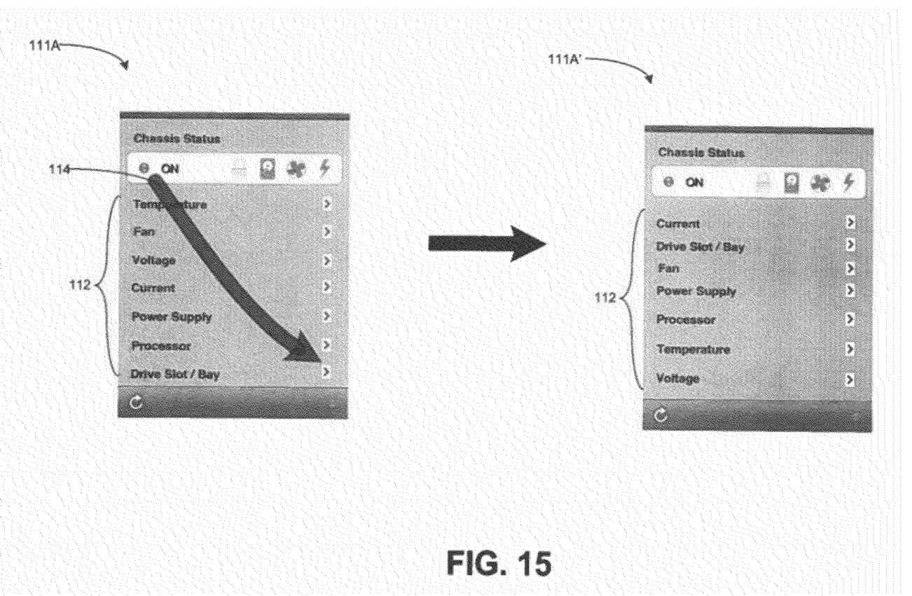

Operation 1410 illustrates displaying a graphical user interface including at least one listing of one or more graphical user interface elements. For example, as shown in FIG. 15, the gesture-based input device 103 may display a UI 111A including one or more controllable device UI elements 112 associated with one or more functions of one or more controllable devices 101.

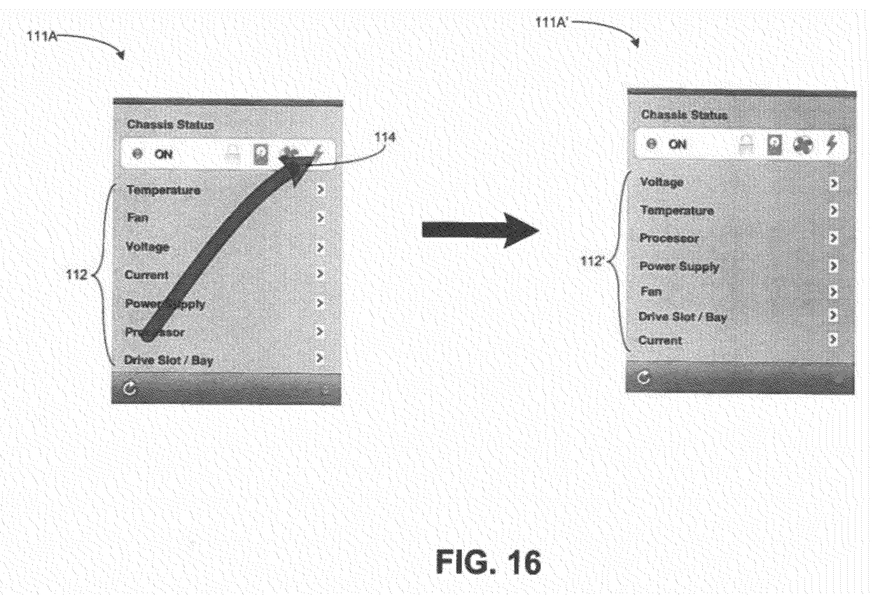

Operation 1420 illustrates receiving at least one gesture-based user input For example, referring to FIGS. 15 and 16, the gesture-based input device 103 may receive a user input 114 (e.g. a user touch applied to a surface of a touch-sensitive screen 106 of the gesture-based input device 103). Referring to FIG. 9, an illustrated view of a user input 114A associated with a controllable device UI element 112A is shown. The user input 114A may be characterized by an at least substantially constant application of pressure (e.g. at no point does the user remove their finger from the surface entirely). Further, the user input 114A may be an at least partially dynamic user input. For example, upon touching the touch-sensitive screen 106, a user may move one or more fingers (e.g. a single finger) across the touch-sensitive screen 106 such as shown by the tracings of user input 114 of FIGS. 15 and 16.

Operation 830 illustrates displaying a graphical user interface including the at least one ordered listing of the one or more graphical user interface elements in response to the at least one gesture-based user input. For example, as shown in FIGS. 15-16, upon receipt of the user input 114 associated the gesture-based input device 103 may display a UI 111A′ including the controllable device UI elements 112 in a particular order according to the nature of the user input 114. For example, as shown in FIG. 15, upon receipt of a user input 114 characterized by a downward and rightward movement of a user's finger on the touch-sensitive screen 106, the gesture-based input device 103 may display a UI 111A′ having listing of controllable device UI elements 112′ in an alphanumerically ascending order. Alternately, as shown in FIG. 16, upon receipt of a user input 114 characterized by a upward and rightward movement of a user's finger on the touch-sensitive screen 106, the gesture-based input device 103 may display a UI 111A′ having listing of controllable device UI elements 112′ that have been sorted in an alphanumerically descending order.

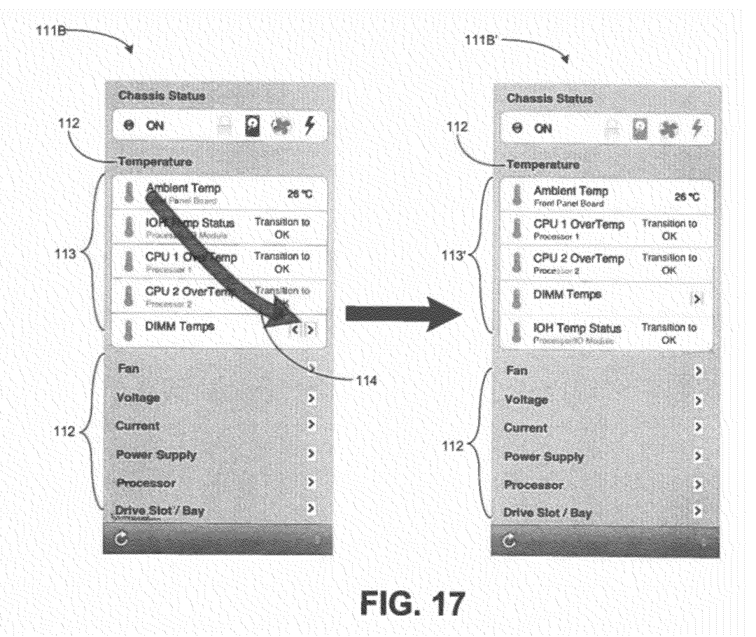

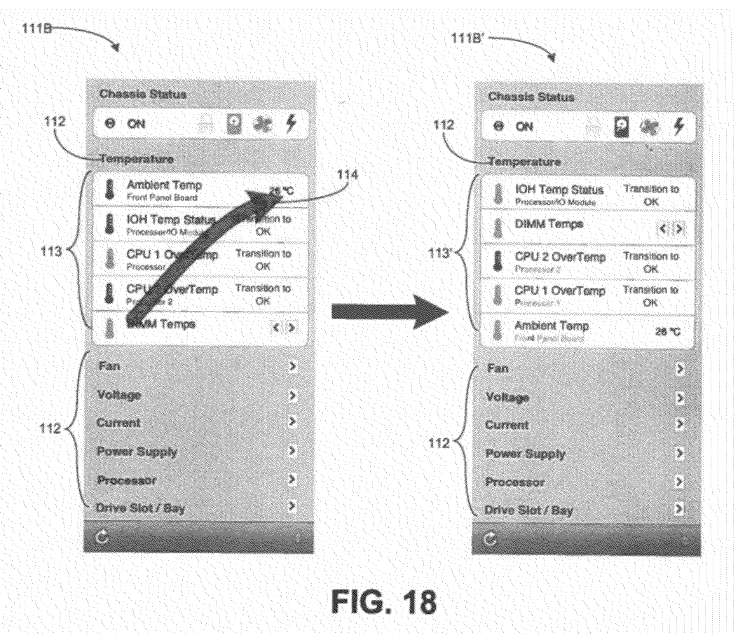

Operations 1410 through 1430 may be conducted in similar fashion with respect to data elements 113 to provide a UI 111 including those data elements 113 in a sorted list. For example, as shown in FIGS. 17-19, the gesture-based input device 103 may display a UI 111B including one or more data elements 113 that are hierarchically dependent from a controllable device UI element 112A. In response to a user input 114 associated with the data elements 113, the gesture-based input device 103 may display a UI 111B including the data elements 113 in a sorted manner. For example, as shown in FIG. 17, the gesture-based input device 103 may receive a user input 114 characterized by a downward and rightward movement of a user's finger on the touch-sensitive screen 106 across one or more data elements 113. The gesture-based input device 103 may display a UI 111B′ including data elements 113′ sorted in a alphanumerically ascending order in response to the user input 114. Alternately, as shown in FIG. 18, may receive a user input 114 characterized by a upward and rightward movement of a user's finger on the touch-sensitive screen 106 across one or more data elements 113. The gesture-based input device 103 the gesture-based input device 103 may display a UI 111B′ including a listing of data elements 113′ that have been sorted in a alphanumerically descending order in response to the user input 114.

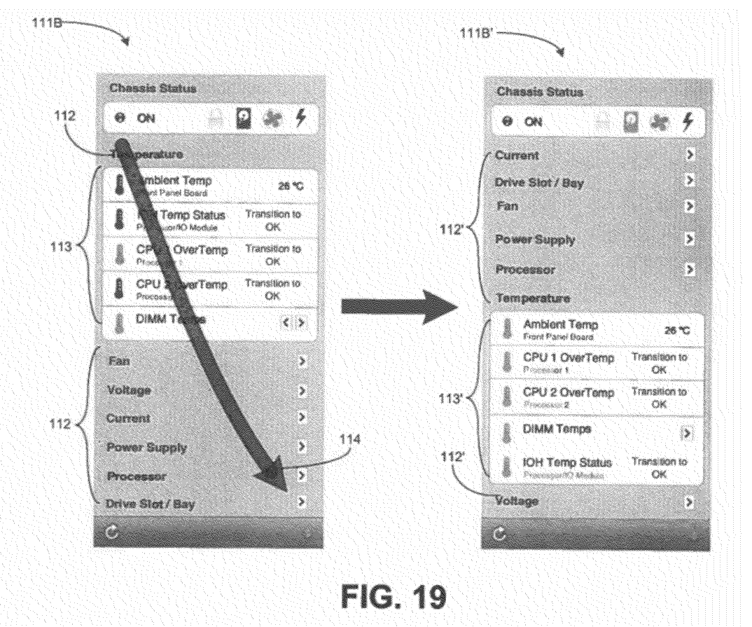

Further, as shown in FIG. 19, the gesture-based input device 103 may simultaneously sort both controllable device UI elements 112 and associated data elements 113 when the user input 114 is associated with both the controllable device UI elements 112 and the data elements 113. For example, the gesture-based input device 103 receive a user input 114 characterized by a downward and rightward movement of a user's finger on the touch-sensitive screen 106 across one or more data elements 113 across both controllable device UI elements 112 and data elements 113. The gesture-based input device 103 may display a UI 111B′ including a listing of both controllable device UI elements 112′ and data elements 113′ that have each been sorted in a alphanumerically ascending order in response to the user input 114.

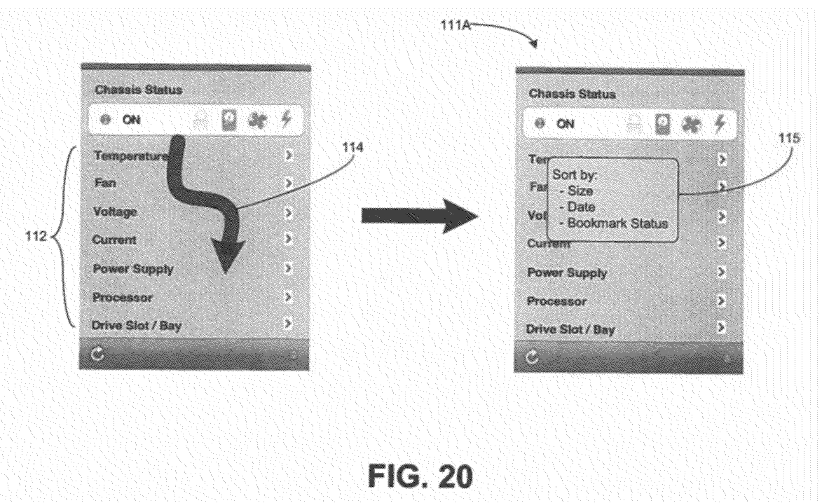

Still further, gesture-based input device 103 may sort any controllable device UI elements 112 of UI 111A according to any number of parameters associated with those elements. For example, the gesture-based input device 103 may sort the controllable device UI elements 112 according to size, search term relevance, bookmark status. As shown in FIG. 20, the gesture-based input device 103 may display a menu 115 including one or more selectable sorting methodologies in response to a user input 114 (e.g. a user input 114 characterized by a zig-zag-type movement of a user's finger on the touch-sensitive screen 106). A user may select from the one or more sorting methodologies and the gesture-based input device 103 may sort the controllable device UI elements 112 accordingly.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein.

More specifically, it will be recognized that, while described in the context of user interfaces configured to control one or more controllable devices, the above described systems and methods may be employed in any number of contexts without departing from the scope of the described invention. For example, the above-described operations associated with the hierarchical display of user interface elements may be employed in any context where data and sub-data providing additional details regarding that data are to be displayed. Similarly, the above-described operations associated with the sorting of user interface elements may be employed in any context where user interface elements are displayed in a list format.

Although specific dependencies have been identified in the claims, it is to be noted that all possible combinations of the features of the claims are envisaged in the present application, and therefore the claims are to be interpreted to include all possible multiple dependencies. It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

What is claimed is:

1. A method for providing user interface elements comprising:
displaying a graphical user interface including at least one graphical user interface element;
receiving at least one gesture-based user input;
displaying a graphical user interface including the at least one graphical user interface element and one or more graphical user interface elements that are hierarchically dependent from the at least one graphical user interface element in response to the at least one gesture-based user input.

2. The method of claim 1,
wherein the displaying a graphical user interface including at least one graphical user interface element further comprises:
displaying at least one second graphical user interface element; and
wherein the displaying a graphical user interface including the at least one graphical user interface element and one or more graphical user interface elements that are hierarchically dependent from the at least one graphical user interface element in response to the at least one gesture-based user input further comprises:
displaying a second graphical user interface including the at least one second graphical user interface element and one or more graphical user interface elements that are hierarchically dependent from the at least one second graphical user interface element in response to the at least one gesture-based user input.

3. The method of claim 1, wherein the receiving at least one gesture-based user input comprises:
receiving at least one touch input to a touch-screen displaying the graphical user interface element.

4. The method of claim 1, wherein the receiving at least one gesture-based user input comprises:
receiving at least one gesture-based user input associated with the at least one graphical user interface element.

5. The method of claim 1
receiving at least one second gesture-based user input;
displaying the first graphical user interface including the at least one graphical user interface element and not including the one or more graphical user interface elements that are hierarchically dependent from the at least one graphical user interface element in response to the at least one second gesture-based user input.

6. The method of claim 5, wherein the receiving at least one second gesture-based user input comprises:
receiving at least one touch input to a touch-screen displaying the graphical user interface element.

7. The method of claim 5, wherein the receiving at least one second gesture-based user input comprises:
receiving at least one gesture-based user input associated with at least one of the at least one graphical user interface element and the one or more graphical user interface elements that are hierarchically dependent from the at least one graphical user interface element.

8. A method for displaying user interface elements comprising:
displaying a graphical user interface including at least one graphical user interface element and one or more graphical user interface elements hierarchically dependent from the at least one graphical user interface element;
receiving at least one gesture-based user input;
displaying a graphical user interface including the at least one graphical user interface element and not including the one or more graphical user interface elements hierarchically dependent from the at least one graphical user interface element in response to the at least one gesture-based user input.

9. The method of claim 8, wherein the receiving at least one gesture-based user input comprises:
receiving at least one touch input to a touch-screen displaying the graphical user interface element.

10. The method of claim 8, wherein the receiving at least one gesture-based user input comprises:
receiving at least one gesture-based user input associated with at least one of the at least one graphical user interface element and the one or more graphical user interface elements that are hierarchically dependent from the at least one graphical user interface element.

11. The method of claim 8,
wherein the displaying a graphical user interface including at least one graphical user interface element and one or more graphical user interface elements hierarchically dependent from the at least one graphical user interface element comprises:
displaying at least one second graphical user interface element and one or more second graphical user interface elements that are hierarchically dependent from the at least one second graphical user interface element; and
wherein the displaying a graphical user interface including the at least one graphical user interface element and not including the one or more graphical user interface elements hierarchically dependent from the at least one graphical user interface element in response to the at least one gesture-based user input comprises:
displaying a graphical user interface including the at least one graphical user interface element and the at least one second graphical user interface element and not including the one or more graphical user interface elements hierarchically dependent from the at least one graphical user interface element and the one or more second graphical user interface elements hierarchically dependent from the at least one second graphical user interface element in response to the at least one gesture-based user input.

12. A method for displaying user interface elements comprising:
displaying a graphical user interface including at least one listing of one or more graphical user interface elements;
receiving at least one gesture-based user input;
displaying a graphical user interface including the at least one ordered listing of the one or more graphical user interface elements in response to the at least one gesture-based user input.

13. The method of claim 12, wherein the displaying a graphical user interface including the at least one ordered listing of the one or more graphical user interface elements in response to the at least one gesture-based user input comprises:
displaying an alphanumerically ascending ordered listing of the one or more graphical user interface elements in response to the at least one gesture-based user input.

14. The method of claim 12, wherein the at least one ordered listing of the one or more graphical user interface elements comprises:
displaying an alphanumerically descending ordered listing of the one or more graphical user interface elements in response to the at least one gesture-based user input.
